(19) United States
(12) Patent Application Publication
(10) Pub. No.: US 2016/0019220 A1
(43) Pub. Date: Jan. 21, 2016

(54) QUERYING A QUESTION AND ANSWER SYSTEM

(71) Applicant: International Business Machines Corporation, Armonk, NY (US)

(72) Inventors: Daniel M. Jamrog, Acton, MA (US); Jason D. LaVoie, Littleton, MA (US); Nicholas W. Orrick, Austin, TX (US); Kristin A. Witherspoon, Somerville, MA (US)

(21) Appl. No.: 14/867,083

(22) Filed: Sep. 28, 2015

Related U.S. Application Data
(63) Continuation of application No. 14/276,049, filed on May 13, 2014.

(51) Int. Cl. G06F 17/30

(52) U.S. Cl. CPC G06F 17/3053; G06F 17/30395

(57) ABSTRACT

A system, a method, and a computer program product of searching a corpus with an unstructured query in a Question and Answering (QA) system are disclosed. The system, the method, and the computer program product include analyzing structural information of an input question. The analyzing may occur in response to parsing the input question. The analyzing may select a first portion of the input question as a first component. The system, the method, and the computer program product include weighting the first component with a first weight. The weighting may be used in a query. The system, the method, and the computer program product include submitting the query to the QA system. The query may include the first component with the first weight.

### TECHNICAL FIELD

This disclosure relates generally to computer systems and, more particularly, relates to a question and answer system.

### BACKGROUND

With the increased usage of computing networks, such as the Internet, humans can be inundated and overwhelmed with the amount of information available to them from various structured and unstructured sources. However, information gaps can occur as users try to piece together what they can find that they believe to be relevant during searches for information on various subjects. To assist with such searches, recent research has been directed to generating Question and Answer (QA) systems which may take an input question, analyze it, and return results to the input question. QA systems provide mechanisms for searching through large sets of sources of content (e.g., electronic documents) and analyze them with regard to an input question to determine an answer to the question.

### SUMMARY

Aspects of the disclosure include a system, a method, and a computer program product of searching a corpus with an unstructured query in a Question and Answering (QA) system. The system, the method, and the computer program product include analyzing structural information of an input question. The analyzing may occur in response to parsing the input question. The analyzing may select a first portion of the input question as a first component. The system, the method, and the computer program product include weighting the first component with a first weight. The weighting may be used in a query. The system, the method, and the computer program product include submitting the query to the QA system. The query may include the first component with the first weight.

Aspects of the disclosure may include the structural information having a set of syntactic categories. In embodiments, the first component can be related to a first syntactic category of the set of syntactic categories. In embodiments, the weighting may be associated with a respective corpus of a plurality of corpora used by the QA system. In embodiments, the weighting associated with the respective corpus may be determined by analyzing the respective corpus. In embodiments, the weighting associated with the respective corpus may be determined by using an algorithm fitting the respective corpus.

Aspects of the disclosure may include developing and submitting a subquery. In embodiments, in response to determining the query did not return the threshold number of candidate answers, a subquery may be developed. In response to developing the subquery, the subquery can be submitted to the QA system. Aspects of the disclosure may have a positive impact on accuracy of search results, number of search results, or performance efficiencies.

### BRIEF DESCRIPTION OF THE DRAWINGS

FIG. 1 is a diagrammatic illustration of an exemplary computing environment, consistent with embodiments of the present disclosure.

FIG. 2 is a system diagram depicting a high level logical architecture for a question answering system, consistent with embodiments of the present disclosure.

FIG. 3 is a block diagram illustrating a question answering system to generate answers to one or more input questions, consistent with various embodiments of the present disclosure.

FIG. 4 is a flowchart illustrating a method of searching a corpus with an unstructured query in a question answering system according to embodiments.

FIG. 5 is a flowchart illustrating a method of searching a corpus with an unstructured query in a question answering system according to embodiments.

FIG. 6 is a flowchart illustrating a method of searching a corpus with an unstructured query in a question answering system according to embodiments.

FIG. 7 is a block diagram illustrating a question answering system to generate answers to one or more input questions, consistent with various embodiments of the present disclosure.

### DETAILED DESCRIPTION

Searches performed by a deep-analytical question and answer system may benefit by using information that is determined about the structure of the question during the natural language processing phase of information-ingestion by the system. The nature of query results when searching unstructured corpora with unstructured queries can be positively impacted. In particular, using parsing and a query that assigns weights to key terms and phrases (e.g., during natural language processing) can produce both result-oriented and performance-oriented efficiencies.

In some systems, words submitted to a deep-analytical question and answer system may be used blindly as-is to build plurality search queries. In such systems, the words may not be associated with each other in a meaningful manner. Queries can be constructed without utilizing advanced parsing or interpretation (e.g., semantic parsing). Such utilization can lead to challenges such as inaccurate search results, voluminous search results, or performance concerns. Such challenges may be eased by parsing an input question, analyzing the input question with respect to sentence structures (key terms, phrases, clause, etc.), assigning a weight to respective key terms/phrases in the unstructured query, and submitting the weighted unstructured query to the system.

Aspects of the disclosure include a system, a method, and a computer program product of searching a corpus with an unstructured query in a Question and Answering (QA) system. The system, the method, and the computer program product include analyzing structural information of an input question. The analyzing may occur in response to parsing the input question. The analyzing may select a first portion of the input question as a first component. The system, the method, and the computer program product include weighting the first component with a first weight. The weighting may be used in a query. The system, the method, and the computer program product include submitting the query to the QA system. The query may include the first component with the first weight.

Aspects of the disclosure may include the structural information having a set of syntactic categories. In embodiments, the first component can be related to a first syntactic category of the set of syntactic categories. In embodiments, the weighting may be associated with a respective corpus of a plurality of corpora used by the QA system. In embodiments, the weighting associated with the respective corpus may be determined by analyzing the respective corpus. In embodiments, the weighting associated with the respective corpus may be determined by using an algorithm fitting the respective corpus.

Aspects of the disclosure may include developing and submitting a subquery. In embodiments, whether the query returns a threshold number of candidate answers can be determined. In response to determining the query did not return the threshold number of candidate answers, the subquery may be developed. The subquery may use a constituent substructure of the query. In response to developing the subquery, the subquery can be submitted to the QA system.

Aspects of the disclosure may include the query including a second component with a second weight. In embodiments, structural information of the input question may be analyzed to select a second portion of the input question as the second component. Such analyzing may occur in response to parsing the input question. The second component can be weighted with the second weight. The query submitted to the QA system may include the second component with the second weight. In embodiments, the first and second portions of the input question can have a common element. In embodiments, the common element may include a first part of the first component and a second part of the second component. Aspects of the disclosure may have a positive impact on accuracy of search results, number of search results, or performance efficiencies.

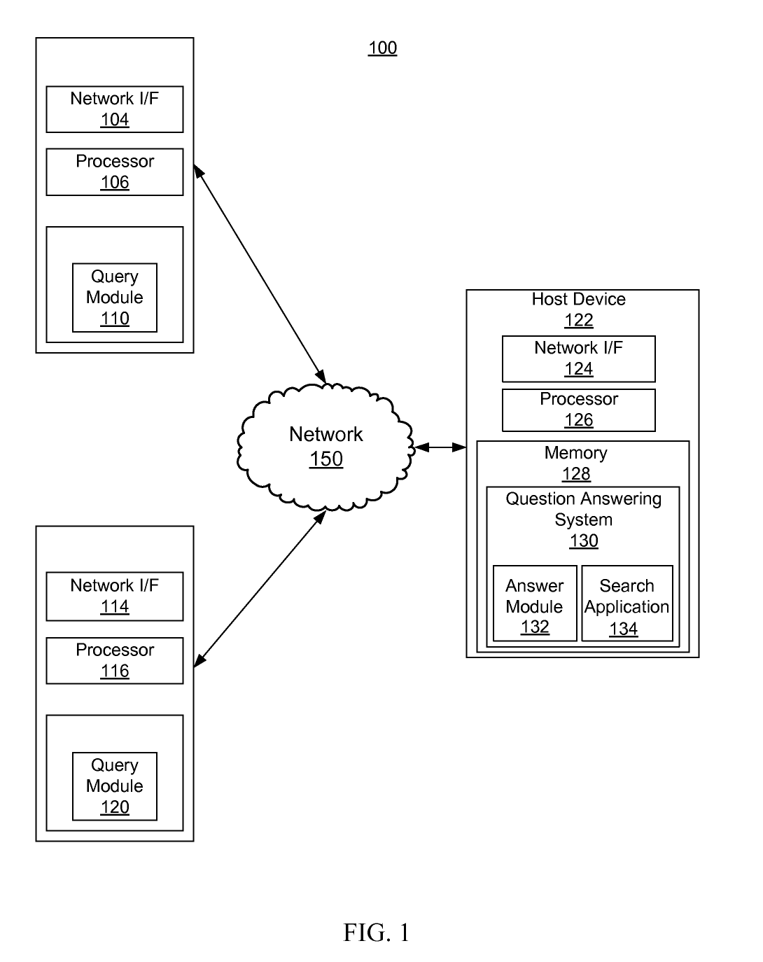

Turning now to the figures, FIG. 1 is a diagrammatic illustration of an exemplary computing environment, consistent with embodiments of the present disclosure. In certain embodiments, the environment 100 can include one or more remote devices 102, 112 and one or more host devices 122. Remote devices 102, 112 and host device 122 may be distant from each other and communicate over a network 150 in which the host device 122 comprises a central hub from which remote devices 102, 112 can establish a communication connection. Alternatively, the host device and remote devices may be configured in any other suitable relationship (e.g., in a peer-to-peer or other relationship).

In certain embodiments the network 100 can be implemented by any number of any suitable communications media (e.g., wide area network (WAN), local area network (LAN), Internet, Intranet, etc.). Alternatively, remote devices 102, 112 and host devices 122 may be local to each other, and communicate via any appropriate local communication medium (e.g., local area network (LAN), hardwire, wireless link, Intranet, etc.). In certain embodiments, the network 100 can be implemented within a cloud computing environment, or using one or more cloud computing services. Consistent with various embodiments, a cloud computing environment can include a network-based, distributed data processing system that provides one or more cloud computing services. In certain embodiments, a cloud computing environment can include many computers, hundreds or thousands of them, disposed within one or more data centers and configured to share resources over the network.

In certain embodiments, host device 122 can include a question answering system 130 (also referred to herein as a QA system) having a search application 134 and an answer module 132. In certain embodiments, the search application may be implemented by a conventional or other search engine, and may be distributed across multiple computer systems. The search application 134 can be configured to search one or more databases or other computer systems for content that is related to a question input by a user at a remote device 102, 112.

In certain embodiments, remote devices 102, 112 enable users to submit questions (e.g., search requests or other queries) to host devices 122 to retrieve search results. For example, the remote devices 102, 112 may include a query module 110 (e.g., in the form of a web browser or any other suitable software module) and present a graphical user (e.g., GUI, etc.) or other interface (e.g., command line prompts, menu screens, etc.) to solicit queries from users for submission to one or more host devices 122 and further to display answers/results obtained from the host devices 122 in relation to such queries.

Consistent with various embodiments, host device 122 and remote devices 102, 112 may be computer systems preferably equipped with a display or monitor. In certain embodiments, the computer systems may include at least one processor 106, 116, 126 memories 108, 118, 128 and/or internal or external network interface or communications devices 104, 114, 124 (e.g., modem, network cards, etc.), optional input devices (e.g., a keyboard, mouse, or other input device), and any commercially available and custom software (e.g., browser software, communications software, server software, natural language processing software, search engine and/or web crawling software, filter modules for filtering content based upon predefined criteria, etc.). In certain embodiments, the computer systems may include server, desktop, laptop, and hand-held devices. In addition, the answer module 132 may include one or more modules or units to perform the various functions of present disclosure embodiments described below (e.g., parsing an input question, analyzing structural information of the input question to select a first portion of the input question as a first component, weighting the first component with a first weight, submitting the query including the first component with the first weight), and may be implemented by any combination of any quantity of software and/or hardware modules or units.

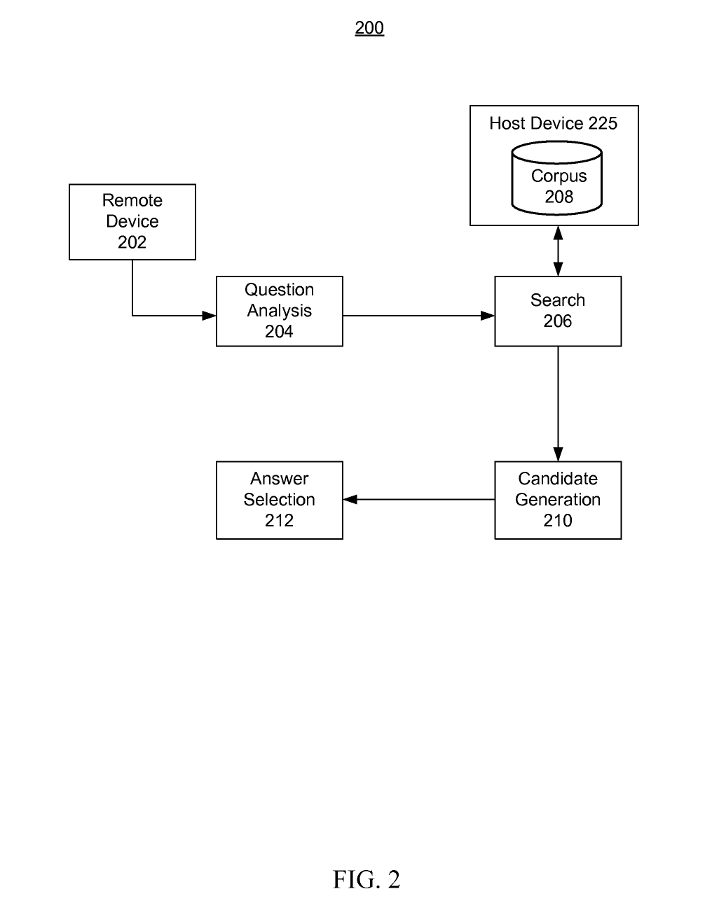

FIG. 2 is a system diagram depicting a high level logical architecture for a question answering system (also referred to herein as a QA system), consistent with embodiments of the present disclosure. Aspects of FIG. 2 are directed toward components for use with a QA system. In certain embodiments, the question analysis component 204 can receive a natural language question from a remote device 202, and can analyze the question to produce, minimally, the semantic type of the expected answer. The search component 206 can formulate queries from the output of the question analysis component 204 and may consult various resources such as the internet or one or more knowledge resources, e.g., databases, corpora 208, to retrieve documents, passages, web-pages, database tuples, etc., that are relevant to answering the question. For example, as shown in FIG. 2, in certain embodiments, the search component 206 can consult a corpus of information 208 on a host device 225. The candidate answer generation component 210 can then extract from the search results potential (candidate) answers to the question, which can then be scored and ranked by the answer selection component 212.

The various components of the exemplary high level logical architecture for a QA system described above may be used to implement various aspects of the present disclosure. For example, the question analysis component 204 could, in certain embodiments, be used to parse an input question or analyze structural information of the input question. Further, the search component 206 can, in certain embodiments, be used to perform a search of a corpus of information 208 in response to submitting a query. The candidate generation component 210 can be used to identify a set of candidate answers based on a weighting methodology. Further, the answer selection component 212 can, in certain embodiments, be used to select one answer of the set of candidate answers based on the weighting methodology.

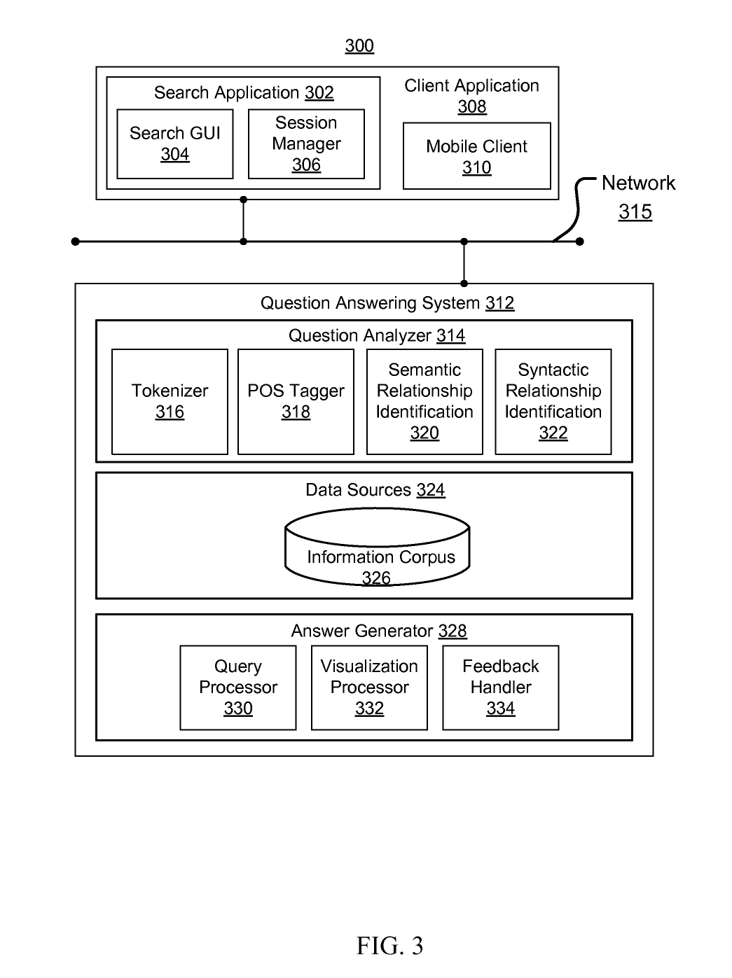

FIG. 3 is a block diagram illustrating a question answering system (also referred to herein as a QA system) to generate answers to one or more input questions, consistent with various embodiments of the present disclosure. Aspects of FIG. 3 are directed toward an exemplary system architecture 300 of a question answering system 312 to generate answers to queries (e.g., input questions). In certain embodiments, one or more users may send requests for information to QA system 312 using a remote device (such as remote devices 102, 112 of FIG. 1). QA system 312 can perform methods and techniques for responding to the requests sent by one or more client applications 308. Client applications 308 may involve one or more entities operable to generate events dispatched to QA system 312 via network 315. In certain embodiments, the events received at QA system 312 may correspond to input questions received from users, where the input questions may be expressed in a free form and in natural language.

A question (similarly referred to herein as a query) may be one or more words that form a search term or request for data, information or knowledge. A question may be expressed in the form of one or more keywords. Questions may include various selection criteria and search terms. A question may be composed of complex linguistic features, not only keywords. However, keyword-based search for answer is also possible. In certain embodiments, using unrestricted syntax for questions posed by users is enabled. The use of restricted syntax results in a variety of alternative expressions for users to better state their needs.

Consistent with various embodiments, client applications 308 can include one or more components such as a search application 302 and a mobile client 310. Client applications 308 can operate on a variety of devices. Such devices include, but are not limited to, mobile and handheld devices, such as laptops, mobile phones, personal or enterprise digital assistants, and the like; personal computers, servers, or other computer systems that access the services and functionality provided by QA system 312. For example, mobile client 310 may be an application installed on a mobile or other handheld device. In certain embodiments, mobile client 310 may dispatch query requests to QA system 312.

Consistent with various embodiments, search application 302 can dispatch requests for information to QA system 312. In certain embodiments, search application 302 can be a client application to QA system 312. In certain embodiments, search application 302 can send requests for answers to QA system 312. Search application 302 may be installed on a personal computer, a server or other computer system. In certain embodiments, search application 302 can include a search graphical user interface (GUI) 304 and session manager 306. Users may enter questions in search GUI 304. In certain embodiments, search GUI 304 may be a search box or other GUI component, the content of which represents a question to be submitted to QA system 312. Users may authenticate to QA system 312 via session manager 306. In certain embodiments, session manager 306 keeps track of user activity across sessions of interaction with the QA system 312. Session manager 306 may keep track of what questions are submitted within the lifecycle of a session of a user. For example, session manager 306 may retain a succession of questions posed by a user during a session. In certain embodiments, answers produced by QA system 312 in response to questions posed throughout the course of a user session may also be retained. Information for sessions managed by session manager 306 may be shared between computer systems and devices.

In certain embodiments, client applications 308 and QA system 312 can be communicatively coupled through network 315, e.g. the Internet, intranet, or other public or private computer network. In certain embodiments, QA system 312 and client applications 308 may communicate by using Hypertext Transfer Protocol (HTTP) or Representational State Transfer (REST) calls. In certain embodiments, QA system 312 may reside on a server node. Client applications 308 may establish server-client communication with QA system 312 or vice versa. In certain embodiments, the network 315 can be implemented within a cloud computing environment, or using one or more cloud computing services. Consistent with various embodiments, a cloud computing environment can include a network-based, distributed data processing system that provides one or more cloud computing services.

Consistent with various embodiments, QA system 312 may respond to the requests for information sent by client applications 308, e.g., posed questions by users. QA system 312 can generate answers to the received questions. In certain embodiments, QA system 312 may include a question analyzer 314, data sources 324, and answer generator 328. Question analyzer 314 can be a computer module that analyzes the received questions. In certain embodiments, question analyzer 314 can perform various methods and techniques for analyzing the questions semantically and syntactically. As is known to those skilled in the art, syntactic analysis relates to the study of a passage or document or according to the rules of a syntax. Syntax is the way (e.g., patterns, arrangements) in which linguistic elements (e.g., words, morphemes) are put together to form natural language components (e.g., phrases, clauses, sentences). In certain embodiments, question analyzer 314 can parse received questions. Question analyzer 314 may include various modules to perform analyses of received questions. For example, computer modules that question analyzer 314 may encompass include, but are not limited to a tokenizer 316, part-of-speech (POS) tagger 318, semantic relationship identification 320, and syntactic relationship identification 322.

Consistent with various embodiments, tokenizer 316 may be a computer module that performs lexical analysis. Tokenizer 316 can convert a sequence of characters into a sequence of tokens. Tokens may be string of characters typed by a user and categorized as a meaningful symbol. Further, in certain embodiments, tokenizer 316 can identify word boundaries in an input question and break the question or any text into its component parts such as words, multiword tokens, numbers, and punctuation marks. In certain embodiments, tokenizer 316 can receive a string of characters, identify the lexemes in the string, and categorize them into tokens.

Consistent with various embodiments, POS tagger 318 can be a computer module that marks up a word in a text to correspond to a particular part of speech. POS tagger 318 can read a question or other text in natural language and assign a part of speech to each word or other token. POS tagger 318 can determine the part of speech to which a word corresponds based on the definition of the word and the context of the word. The context of a word may be based on its relationship with adjacent and related words in a phrase, sentence, question, or paragraph. In certain embodiments, context of a word may be dependent on one or more previously posed questions. Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs, conjunctions, determiners, negative particles, possessive markers, prepositions, wh-pronouns, and the like. In certain embodiments, POS tagger 316 can tag or otherwise annotates tokens of a question with part of speech categories. In certain embodiments, POS tagger 316 can tag tokens or words of a question to be parsed by QA system 312.

Consistent with various embodiments, semantic relationship identification 320 may be a computer module that can identify semantic relationships of recognized entities in questions posed by users. In certain embodiments, semantic relationship identification 320 may determine functional dependencies between entities, the dimension associated to a member, and other semantic relationships.

Consistent with various embodiments, syntactic relationship identification 322 may be a computer module that can identify syntactic relationships in a question composed of tokens posed by users to QA system 312. Syntactic relationship identification 322 can determine the grammatical structure of sentences, for example, which groups of words are associated as “phrases” and which word is the subject or object of a verb. In certain embodiments, syntactic relationship identification 322 can conform to a formal grammar.

In certain embodiments, question analyzer 314 may be a computer module that can parse a received query and generate a corresponding data structure of the query. For example, in response to receiving a question at QA system 312, question analyzer 314 can output the parsed question as a data structure. In certain embodiments, the parsed question may be represented in the form of a parse tree or other graph structure. To generate the parsed question, question analyzer 130 may trigger computer modules 132-144. Question analyzer 130 can use functionality provided by computer modules 316-322 individually or in combination. Additionally, in certain embodiments, question analyzer 130 may use external computer systems for dedicated tasks that are part of the question parsing process.

Consistent with various embodiments, the output of question analyzer 314 can be used by QA system 312 to perform a search of one or more data sources 324 to retrieve information to answer a question posed by a user. In certain embodiments, data sources 324 may include data warehouses, information corpora, data models, and document repositories. In certain embodiments, the data source 324 can be an information corpus 326. The information corpus 326 can enable data storage and retrieval. In certain embodiments, the information corpus 326 may be a storage mechanism that houses a standardized, consistent, clean and integrated form of data. The data may be sourced from various operational systems. Data stored in the information corpus 326 may be structured in a way to specifically address reporting and analytic requirements. In one embodiment, the information corpus may be a relational database. In some example embodiments, data sources 324 may include one or more document repositories.

In certain embodiments, answer generator 328 may be a computer module that generates answers to posed questions. Examples of answers generated by answer generator 328 may include, but are not limited to, answers in the form of natural language sentences; reports, charts, or other analytic representation; raw data; web pages, and the like.

Consistent with various embodiments, answer generator 328 may include query processor 330, visualization processor 332 and feedback handler 334. When information in a data source 324 matching a parsed question is located, a technical query associated with the pattern can be executed by query processor 330. Based on retrieved data by a technical query executed by query processor 330, visualization processor 332 can render visualization of the retrieved data, where the visualization represents the answer. In certain embodiments, visualization processor 332 may render various analytics to represent the answer including, but not limited to, images, charts, tables, dashboards, maps, and the like. In certain embodiments, visualization processor 332 can present the answer to the user in understandable form.

In certain embodiments, feedback handler 334 can be a computer module that processes feedback from users on answers generated by answer generator 328. In certain embodiments, users may be engaged in dialog with the QA system 312 to evaluate the relevance of received answers. Answer generator 328 may produce a list of answers corresponding to a question submitted by a user. The user may rank each answer according to its relevance to the question. In certain embodiments, the feedback of users on generated answers may be used for future question answering sessions.

The various components of the exemplary question answering system described above may be used to implement various aspects of the present disclosure. For example, the client application 308 could be used to receive an input question from a user. The question analyzer 314 could, in certain embodiments, be used to analyze structural information of the input question to select a first portion of the input question as a first component. Further, the query processor 330 could, in certain embodiments, be used to submit the query including the first component with the first weight. The answer generator 328 can be used to identify a set of answers using the weighting.

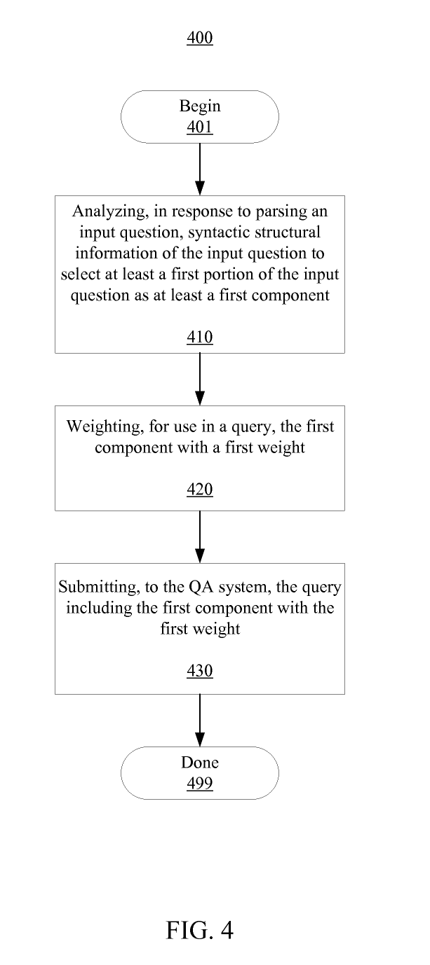

FIG. 4 is a flowchart illustrating a method 400 of searching a corpus with an unstructured query in a Question and Answering (QA) system according to embodiments. The method 400 begins at block 401. At block 410, syntactic structural information of an input question is analyzed. The syntactic structural information can have a set of syntactic categories. In embodiments, a first component can be related to a first syntactic category of the set of syntactic categories. A part of speech (e.g., noun, verb, preposition) may be a specific syntactic category. The part of speech may be a member of a lexical category (e.g., adjective, adposition (preposition, postposition, circumposition), adverb, coordinate conjunction, determiner, interjection, noun, particle, pronoun, subordinate conjunction, verb). A phrasal category (e.g., noun phrase, verb phrase, propositional phrase, adjective phrase, adverb phrase, adposition phrase) may be another syntactic category. In embodiments, components may be divided into morphemes, words, phrases, phases, sentences (clauses), and text. For instance, the first component may be a word, the word can be related to the first syntactic category which may be a noun phrase, and the noun phrase can be one syntactic category of the set of syntactic categories which may be phrasal categories.

In embodiments the analyzing at block 410 can include, for example, concept detection, semantic relation detection, or verb tense annotators. The analyzing may occur in response to parsing the input question. Parsing the input question can include, for example, performing semantic, syntactic, or grammatical parsing. In embodiments, a parse tree may be used. The analyzing may select a first portion of the input question as the first component. To illustrate, consider a particular input question of “Where will the Winter Olympics be held in 2026?” The particular input question may be parsed syntactically into syntactic categories such as a phrasal category (e.g., “Winter Olympics” may be a noun phrase). Particular structural information (e.g., syntactic categories such as phrasal categories) may be analyzed for the particular input question. A particular portion (e.g., a phrase) of the particular input question may be selected as a particular first component (e.g., a phrase that is a noun phrase). For example with regard to the particular input question of “Where will the Winter Olympics be held in 2026?”, the particular first component may be “Winter Olympics” in response to selecting a noun phrase. In embodiments, choosing to select the noun phrase may be performed for the subject (or object, etc.) of the input question.

At block 420, the first component is weighted with a first weight. The weighting may be used in a query. In embodiments, certain syntactic categories can be assigned relatively greater weights. For example, noun phrases may be assigned greater weights than prepositional phrases. Using the example of the particular input question of “Where will the Winter Olympics be held in 2026?”, the particular first component may be “Winter Olympics” (a noun phrase) and a particular second component may be “in 2026” (a prepositional phrase). In such example, “Winter Olympics” may be weighted with a first weight of “10” while “in 2026” may be weighted with a second weight of “4.” These weights may then be used in the query.

In embodiments, the weighting may be associated with (e.g., selected for, tuned for) a respective corpus of a plurality of corpora used by the QA system. For example, in a specific respective corpus about the Winter Olympics, the weighting may be tuned to give a relatively greater weight to prepositional phrases including years such as “in 2026” (a specific year may filter results well in the specific respective corpus) and a relatively lesser weight to noun phrases containing only the words “Winter Olympics” (which may apply to the entirety of the specific respective corpus). In embodiments, the weighting associated with the respective corpus may be determined by analyzing the respective corpus. For example, in a particular respective corpus about the International Olympic Committee, analysis may choose to weight highly the words “Winter” and “Summer” so as to help answer questions regarding when and where (possibly because Winter games are currently held in non-U.S. Presidential Election years and Summer games are currently held in U.S. Presidential Election years).

In embodiments, the weighting associated with the respective corpus may be determined by using an algorithm fitting the respective corpus (e.g., based on corpus attributes). For instance, key terms and phrases may be weighted according to a set of algorithms fitting a set of corpora being searched (e.g., use Inverse Document Frequency (IDF) scores from a corpus of query terms/phrases found in the input question to assign weights—terms/phrases with greater IDF scores (those which are more unique) can be assigned greater weights). As an example for the particular respective corpus about the International Olympic Committee, the set of algorithms may determine whether dates described as four-digit years fit as a year where Olympic Games will be held (such years may be given a greater weight). Another possibility includes weighting based on question attributes (e.g., using a lexical answer type of question to assign query weights—query terms/phrases of desired entity type may be assigned greater weights). In embodiments, query expansion techniques relying on the set of corpora or external resources may or may not be used or required (e.g., weighting may allow for positive performance impacts without query expansion). For the particular respective corpus, adverbs as the first or second word of a sentence (e.g., “Where”) may be given greater weight than prepositions near the end of the sentence (e.g., “in”).

At block 430, the query is submitted to the QA system. Submission could include a transmission of a set of data or packets. Submission may be within the QA system from a first module to a second module. In embodiments, a plurality of the operations defined herein (including submission) could occur within one module. The query may include the first component with the first weight. The weight could be a numerical value and could be connected to the first component through means such as the use of a multiplication symbol or parentheses.

Consider an example with regard to the particular input question of “Where will the Winter Olympics be held in 2026?” Without method 400, the query may weight each word the same (e.g., effectively with a “1”), such as: #weight(1*Where 1*will 1*the 1*Winter 1*Olympics 1*be 1*held 1*in 1*2026). Query results for the query without method 400 may include information (or too much information, or unwanted results near the top of the list) related to the Summer Olympics, to elections held in 2026, to World Cup events, to projected financial events in 2026, or to environmental forecasts. Using method 400, key terms and phrases may be weighted relatively more heavily, the query may be: #weight(6*Where 1*will 0*the 10*(“Winter Olympics”) 0*be 2*held 1*in 5*2026 #combine(3*(+(2026)+(“Winter Olympics”)))). Query results for the query with method 400 may focus the query appropriately. In the example, information returned may be focused on the Winter Olympics (uncluttered by results including the Summer Olympics), may be focused on the year 2026 (and not just any future Olympics), may be focused on location information (e.g., where) and not on a variety of other matters. The method 400 concludes at block 499. Aspects of the method 400 may have a positive impact on accuracy of search results, number of search results, or performance efficiencies.

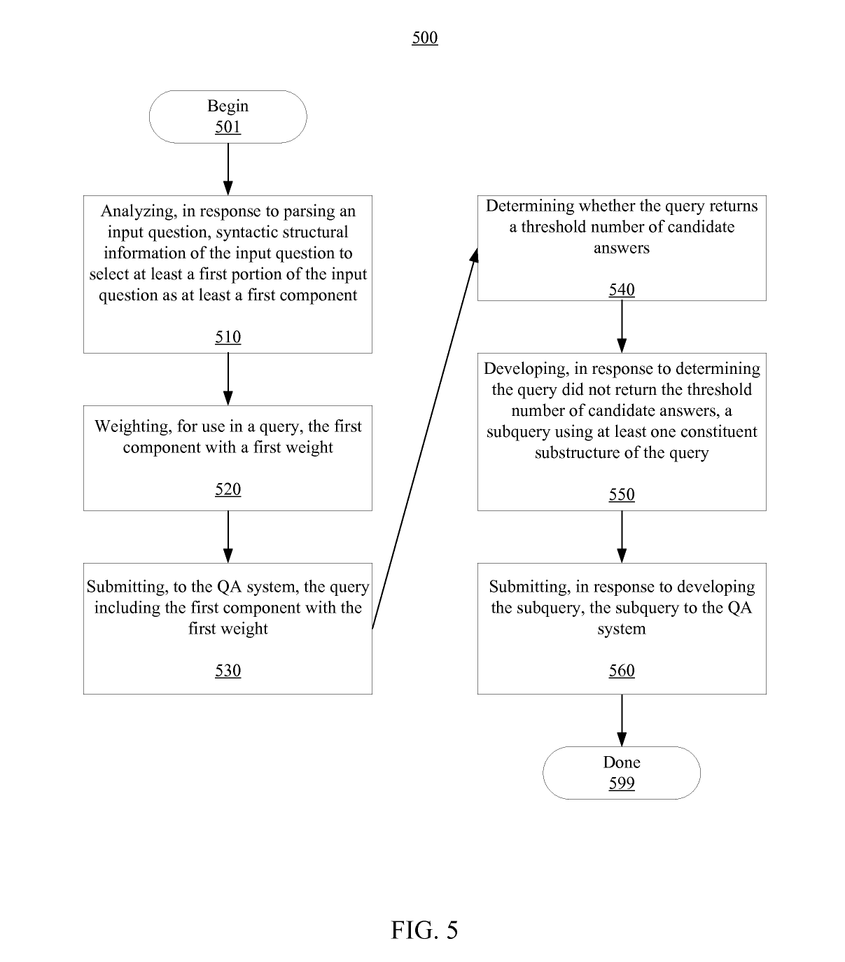

FIG. 5 is a flowchart illustrating a method 500 of searching a corpus with an unstructured query in a Question and Answering (QA) system according to embodiments. Method 500 may include developing and submitting a subquery. Aspects of method 500 may be similar to or the same as aspects of method 400. The method 500 begins at block 501. At block 510, syntactic structural information of an input question is analyzed. The analyzing may occur in response to parsing the input question. The analyzing may select a first portion of the input question as a first component. For example, the input question may be: “I want a resort near a large body of water in the springtime where I can fish but don't have to deal with spring breakers or their substance use while also being able to do some Spring Training and maybe catch some Rays in the afternoon.” Analyzing syntactic structural information may include identifying words or phrases that are capitalized, such as “Spring Training” or “Rays.” The portion of the input question which is the phrase “Spring Training” may be selected as the first component. At block 520, the first component is weighted with a first weight. In the example, “Spring Training” may be given a relatively significant weight of “95.” The weighting may be used in a query. At block 530, the query is submitted to the QA system. The query may include the first component with the first weight. The example query may be: #weight(1*I 0*want 0*a 12*resort 1*near 0*a 20*(“large body of water”) 0*in 0*the 15*springtime 5*where 1*I 0*can 50*fish 0*but 0*don't 0*have 0*to 4*deal 0*with 10*spring 5*breakers 15*(“no spring breakers”) 0*or 0*their 3*substance 0*use 15*(“no substance use”) 0*while 0*also 0*being 0*able 0*to 0*do 2*some 15*Spring 6*Training 95*(“Spring Training”) 1*and 1*maybe 3*catch 1*some 8*Rays 30*(“catch some Rays”) 0*in 0*the 3*afternoon 2*(“catch some Rays in the afternoon”).”

At block 540, whether the query returns a threshold number of candidate answers can be determined. The threshold number of candidate answers can be an arithmetic count of candidate answers to the query. For example, too few candidate answers may be returned (e.g., fishing for Rays in the springtime may not be compatible with enough resort destinations). Other times, too many candidate answers may be returned (e.g., resorts near large bodies of water may be plentiful). In either case, the determination at block 540 may be made.

At block 550, the subquery may be developed. Development of the subquery may occur in response to determining the query did not return the threshold number of candidate answers. The subquery may use a constituent substructure (e.g., of the set of syntactic categories described with respect to method 400) of the query. In the example, the subquery may focus further on certain aspects of the query such as phrases (perhaps, in particular, those which have been weighted). Combinations of the set of syntactic categories are considered. Using previously weighted phrases with the example, subquery may be: #weight(20*(“large body of water”) 15*(“no spring breakers”) 15*(“no substance use”) 95*(“Spring Training”) 30*(“catch some Rays”) 2*(“catch some Rays in the afternoon”)).

At block 560, the subquery can be submitted to the QA system. Submission of the subquery can occur in response to developing the subquery. This might lead to a weighted search term or might help return a configurable amount of candidate answers (rather than few/many relevant answers without it). For example, the subquery may lead to further weighting of the word “Rays” to better decide (e.g., using another subquery or other means) whether the subject matter is a type of fish, sunlight, or a professional baseball team. The subquery might help return a configurable amount of candidate answers of, for example, places to watch baseball in Florida on March afternoons (in particular places not known as spring break destinations). A number of possibilities are contemplated. The method 500 concludes at block 599. Aspects of the method 500 may have a positive impact on accuracy of search results, number of search results, or performance efficiencies.

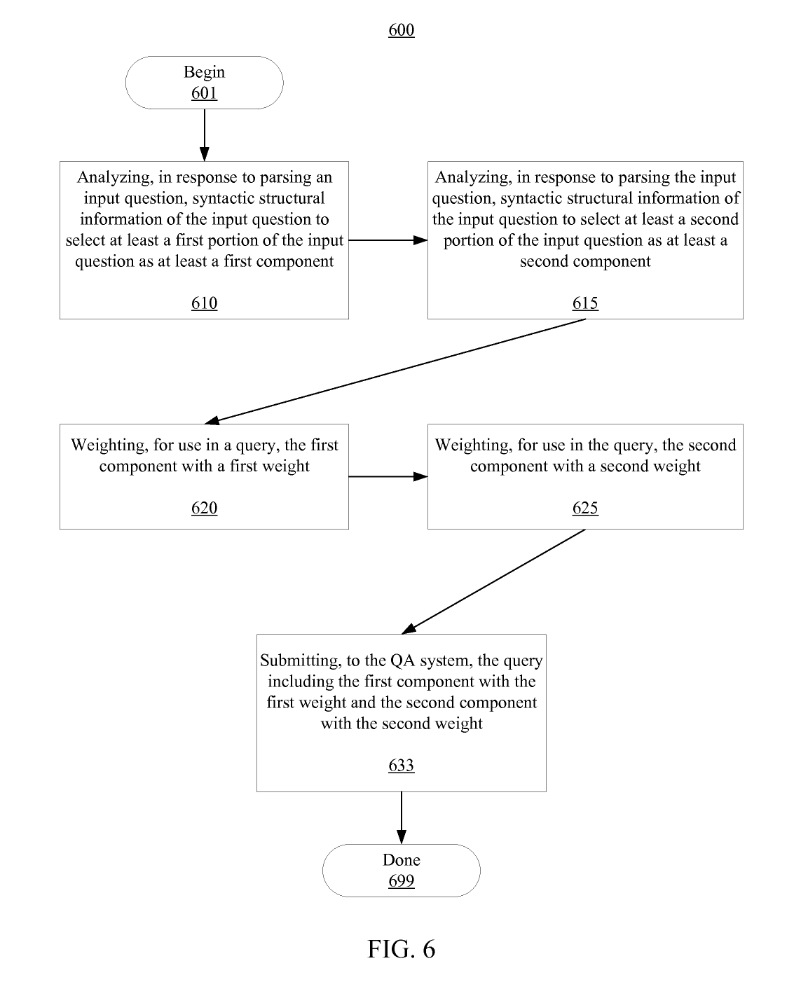

FIG. 6 is a flowchart illustrating a method 600 of searching a corpus with an unstructured query in a Question and Answering (QA) system according to embodiments. Aspects of method 600 may be similar to or the same as aspects of method 400. The method 600 begins at block 601. At block 610, syntactic structural information of an input question is analyzed. The analyzing may occur in response to parsing the input question. The analyzing may select a first portion of the input question as a first component. At block 615, the analyzing may select a second portion of the input question as a second component. At block 620, the first component is weighted with a first weight. At block 625, the second component can be weighted with the second weight (which may be different from the first weight). The weighting may be used in a query. At block 633, the query is submitted to the QA system. The query may include the first component with the first weight and the second component with the second weight. Multiple components with multiple weights are shown in the above example queries #weight(6*Where 1*will 0*the 10*(“Winter Olympics”) 0*be 2*held 1*in 5*2026 #combine(3*(+(2026)+(“Winter Olympics”)))) and #weight(1*I 0*want 0*a 12*resort 1*near 0*a 20*(“large body of water”) 0*in 0*the 15*springtime 5*where 1*I 0*can 50*fish 0*but 0*don't 0*have 0*to 4*deal 0*with 10*spring 5*breakers 15*(“no spring breakers”) 0*or 0*their 3*substance 0*use 15*(“no substance use”) 0*while 0*also 0*being 0*able 0*to 0*do 2*some 15*Spring 6*Training 95*(“Spring Training”) 1*and 1*maybe 3*catch 1*some 8*Rays 30*(“catch some Rays”) 0*in 0*the 3*afternoon 2*(“catch some Rays in the afternoon”).

Overlapping sentence structures may exist. For instance, phrases can overlap with adverbs and both may be weighted. In embodiments, the first and second portions of the input question can have a common element. For example, in the input question “I want a resort near a large body of water in the springtime where I can fish but don't have to deal with spring breakers or their substance use while also being able to do some Spring Training and maybe catch some Rays in the afternoon.”, the phrase “resort near a large body of water” overlaps with “large body of water in the springtime where I can fish.” Each of these different phrases (and fractions of them such as constituent substructures) can be weighted for use in queries or subqueries. Embodiments may include instances where syntactic categories do not happen to be immediately adjacent in the sentence. For example, nouns and noun phrases may be combined for a specific query (e.g., “Spring Training resort”). In embodiments, words may be slightly altered and may happen to combine it with another word for a query or subquery (e.g., changing fish to fishing in order to combine it with “fishing resort”). The method 600 concludes at block 699. Aspects of the method 600 may have a positive impact on accuracy of search results, number of search results, or performance efficiencies.

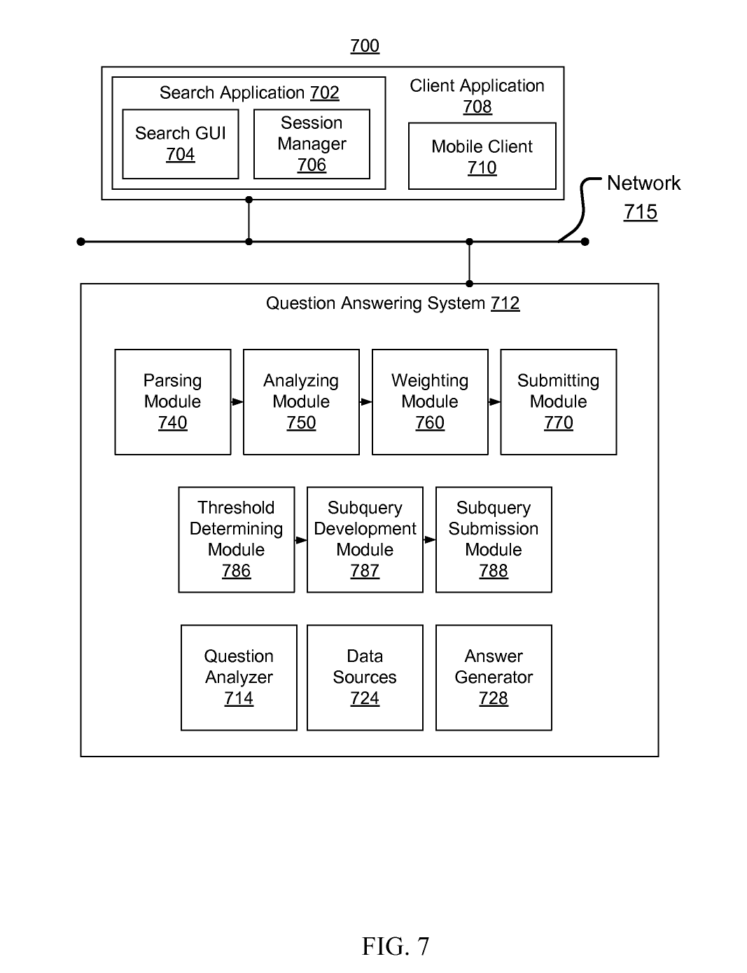

FIG. 7 is a block diagram illustrating a question answering system (also referred to herein as a QA system) to generate answers to one or more input questions, consistent with various embodiments of the present disclosure. Aspects of FIG. 7 are directed toward an exemplary system architecture 700 of a question answering system 712. Aspects of FIG. 7 may be similar or the same to systems described previously (e.g., system architecture 300) or methodologies described previously (e.g., method 400). In certain embodiments, one or more users may send requests for information to QA system 712 using a remote device (such as remote devices 102, 112 of FIG. 1). QA system 712 can perform methods and techniques for responding to the requests sent by one or more client applications 708. Client applications 708 may involve one or more entities operable to generate events dispatched to QA system 712 via network 715. In certain embodiments, the events received at QA system 712 may correspond to input questions received from users, where the input questions may be expressed in a free form and in natural language.

Consistent with various embodiments, client applications 708 can include one or more components such as a search application 702 and a mobile client 710. Client applications 308 can operate on a variety of devices. Such devices include, but are not limited to, mobile and handheld devices, such as laptops, mobile phones, personal or enterprise digital assistants, and the like; personal computers, servers, or other computer systems that access the services and functionality provided by QA system 712. For example, mobile client 710 may be an application installed on a mobile or other handheld device. In certain embodiments, mobile client 710 may dispatch query requests to QA system 712.

Consistent with various embodiments, search application 702 can dispatch requests for information to QA system 712. In certain embodiments, search application 702 can be a client application to QA system 712. In certain embodiments, search application 702 can send requests for answers to QA system 712. Search application 702 may be installed on a personal computer, a server or other computer system. In certain embodiments, search application 702 can include a search graphical user interface (GUI) 704 and session manager 706. Users may enter questions in search GUI 304. In certain embodiments, search GUI 704 may be a search box or other GUI component, the content of which represents a question to be submitted to QA system 712. Users may authenticate to QA system 712 via session manager 706. In certain embodiments, session manager 706 keeps track of user activity across sessions of interaction with the QA system 712. Session manager 706 may keep track of what questions are submitted within the lifecycle of a session of a user. For example, session manager 706 may retain a succession of questions posed by a user during a session. In certain embodiments, answers produced by QA system 712 in response to questions posed throughout the course of a user session may also be retained. Information for sessions managed by session manager 706 may be shared between computer systems and devices.

In certain embodiments, client applications 708 and QA system 712 can be communicatively coupled through network 715, e.g. the Internet, intranet, or other public or private computer network. In certain embodiments, QA system 712 and client applications 708 may communicate by using Hypertext Transfer Protocol (HTTP) or Representational State Transfer (REST) calls. In certain embodiments, QA system 712 may reside on a server node. Client applications 708 may establish server-client communication with QA system 712 or vice versa. In certain embodiments, the network 715 can be implemented within a cloud computing environment, or using one or more cloud computing services. Consistent with various embodiments, a cloud computing environment can include a network-based, distributed data processing system that provides one or more cloud computing services.

Consistent with various embodiments, QA system 712 may respond to the requests for information sent by client applications 708, e.g., posed questions by users. QA system 712 can generate answers to the received questions. In certain embodiments, QA system 712 may include a question analyzer 714, data sources 724, and answer generator 728. Question analyzer 714 can be a computer module that analyzes the received questions. In certain embodiments, question analyzer 714 can perform various methods and techniques for analyzing the questions.

Consistent with various embodiments, the output of question analyzer 714 can be used by QA system 712 to perform a search of one or more data sources 724 to retrieve information to answer a question posed by a user. In certain embodiments, data sources 724 may include data warehouses, information corpora, data models, and document repositories. In certain embodiments, answer generator 728 may be a computer module that generates answers to posed questions. Examples of answers generated by answer generator 728 may include, but are not limited to, answers in the form of natural language sentences; reports, charts, or other analytic representation; raw data; web pages, and the like.

The QA system 712 can include an analyzing module 750 to analyze syntactic structural information of an input question. The analyzing may occur in response to parsing the input question by a parsing module 740. The analyzing may select a first portion of the input question as a first component. In embodiments, syntactic structural information of the input question may be analyzed to select a second portion of the input question as a second component. The QA system 712 can include a weighting module 760 to weight the first component with a first weight. In embodiments, the weighting module 760 may include the query including the second component with a second weight. The weighting may be used in a query. The QA system 712 can include a submitting module 770 to submit the query to the QA system. The query may include the first component with the first weight. In embodiments, the query submitted to the QA system may include the second component with the second weight.

In embodiments, the first and second portions of the input question can have a common element. In embodiments, the common element may include a first part of the first component and a second part of the second component. The syntactic structural information may have a set of syntactic categories. In embodiments, the first component can be related to a first syntactic category of the set of syntactic categories. In embodiments, the weighting may be associated with a respective corpus of a plurality of corpora used by the QA system 712. In embodiments, the weighting module 760 may be associated with the respective corpus to determine weighting by analyzing the respective corpus. In embodiments, the weighting associated with the respective corpus may be determined by using an algorithm fitting the respective corpus.

In embodiments, whether the query returns a threshold number of candidate answers can be determined using a threshold determining module 786. In response to determining the query did not return the threshold number of candidate answers, the subquery may be developed using a subquery development module 787. The subquery may use a constituent substructure of the query. In response to developing the subquery, the subquery can be submitted to the QA system using a subquery submission module 788. Aspects of the QA system 712 may have a positive impact on accuracy of search results, number of search results, or performance efficiencies.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow.

What is claimed is:

1. A computer-implemented method of searching a corpus with an unstructured query in a Question and Answering (QA) system, the method comprising:
analyzing, in response to parsing an input question, syntactic structural information of the input question to select a first portion of the input question as a first component and a second portion of the input question as a second component;
weighting, for use in a query, the first component with a first weight and the second component with a second weight, wherein the first and second weights are different; and
submitting, to the QA system, the query including the first component with the first weight and the second component with the second weight.

2. The method of claim 1, wherein the weighting is associated with a respective corpus of a plurality of corpora used by the QA system.

3. The method of claim 1, further comprising:
determining whether the query returns a threshold number of candidate answers;
developing, in response to determining the query did not return the threshold number of candidate answers, a subquery using a constituent substructure of the query; and
submitting, in response to developing the subquery, the subquery to the QA system.

4. The method of claim 1, wherein the syntactic structural information includes a set of syntactic categories and the first component is related to a first syntactic category of the set of syntactic categories.

5. The method of claim 1, further comprising:
analyzing, in response to parsing the input question, syntactic structural information of the input question to select a third portion of the input question as a third component;
weighting, for use in the query, the third component with a third weight; and
submitting, to the QA system, the query including the third component with the third weight.

6. The method of claim 1, wherein the first and second portions of the input question have a common element.

7. The method of claim 6, wherein the common element includes a first part of the first component and a second part of the second component.

8. The method of claim 2, further comprising determining the weighting associated with the respective corpus by analyzing the respective corpus or using an algorithm fitting the respective corpus.
